(19) United States
(12) Patent Application Publication
(10) Pub. No.: US 2006/0063016 A1
(43) Pub. Date: Mar. 23, 2006

(54) Metallic laminate and method for preparing thereof

(76) Inventors: Joo-eun Ko, Daejeon (KR); Soon-yong Park, Daejeon (KR); Heon-sik Song, Daejeon (KR)

Correspondence Address: MCKENNA LONG & ALDRIDGE LLP, 1900 K STREET, NW, WASHINGTON, DC, 20006, US

(21) Appl. No.: 11/229,851

(22) Filed: Sep. 20, 2005

(30) Foreign Application Priority Data
Sep. 21, 2004 (KR) 10-2004-0075635

(51) Int. Cl. B32B 15/08

(52) U.S. Cl. 428/458; 427/372.2

(57) ABSTRACT

The present invention relates to a metallic laminate for printed-circuit base board composed of two low thermal expansion polyimide resin layers having thermal expansion coefficient of up to 20 ppm/□, a metal conductor layer, and a high thermal expansion polyimide resin layer having thermal expansion coefficient of more than 20 ppm/□ which is loaded on the above low thermal expansion polyimide resin layers, and a preparation method of the same.

### TECHNICAL FIELD

The present invention relates to a metallic laminate for printed-circuit base board and a preparation method thereof, more precisely, a metallic laminate for printed-circuit base board showing excellent dimensional stability against temperature change and reliability of adhesive force and uniformity before and after etching that is composed of two low thermal expansion polyimide resin layers having thermal expansion coefficient of up to 20 ppm/° C., a metallic conductor layer and a high thermal expansion polyimide resin layer having thermal expansion coefficient of more than 20 ppm/° C. loaded over the low thermal expansion polyamide resin layers, and a preparation method of the same.

### BACKGROUND ART

According to a trend of miniaturization and multifunctionalization of electronic machines, in particular in the field of portable instruments, high density printed-circuit base boards are required to produce electronic equipments. To meet the need, multilamination of circuit board has been generally applied. In addition, flexible printed-circuit base board which can be established in a narrow space and narrow line circuit to secure large numbers of circuits in a limited space has also been used. In the meantime, to avoid environmental problems caused by soldering for multilamination, an adhesive not including lead is now a primary concern. So, it is highly required to develop an adhesive for multilamination of circuit board which has high adhesive force, thermal resistance and low absorption rate.

As proved in Korean Patent Application No. 2000-73384 (Applicant: LG Chem, Ltd., Korea), the conventional metallic laminates prepared by adhering polyimide film and metal foil with the acryl or epoxy adhesive are inappropriate to be used in circuit boards asking multilamination, flexibility, high adhesive force and thermal resistance. Thus, double layer flexible metallic laminate in which polyimide and metal foil are directly adhered on each other without an adhesive has been developed.

The double layer metallic laminate is formed by direct adhesion of metal foil, more preferably copper (Cu) foil, with polyimide film without using an adhesive. Therefore, unlike the conventional 3CCL (3-layer copper clad laminate) in which copper foil and polyimide film are adhered on each other by an adhesive, the double layer metallic laminate showing thermal stability and excellent durability and electronic properties is a very promising candidate for a flexible circuit base board material.

Numbers of study results on such double layer metallic laminate have been reported. At first, 2CCL (2-Layer Copper Clad Laminate) was produced by using copper foil as a metallic conductor. At that time, polyimide resin having bigger thermal expansion coefficient than 20 ppm/□ was loaded on copper foil, affecting dimensional stability with the temperature change that means the laminate contracts or expands when temperature goes up or down.

Regarding flexible printed-circuit base board, the one with unilateral structure having a conductor layer on one side and the other with bilateral structure having conductor layers on both sides leaving insulator layer in between them have been put to practical use. However, the laminate having bilateral structure has low flexibility, compared with flexible printed-circuit base board having unilateral structure.

### DISCLOSURE OF THE INVENTION

The present inventors made every effort to overcome the above problems of the conventional metallic laminate for printed-circuit base board. As a result, the present inventors completed this invention by confirming that the multiple laminates of insulator with polyimide resins having different thermal expansion coefficients on metallic conductor layer enables the production of double layer metallic laminate showing excellent dimensional stability even with the temperature changes, and reliability of adhesive force, uniformity before and after etching, and chemical resistance. More precisely, the present inventors proved that double layer metallic laminate having excellent properties such as dimensional stability, adhesive force, uniformity, and chemical resistance can be produced by realizing multiple laminates by loading high thermal expansion polyimide resin having thermal expansion coefficient of more than 20 ppm/° C. on two low thermal expansion polyimide resins having thermal expansion coefficient of up to 20 ppm/° C.

Therefore, it is an object of the present invention to provide a double layer metallic laminate for flexible printed-circuit base board composed of two low thermal expansion polyimide resins having thermal expansion coefficient of up to 20 ppm/° C., a metallic conductor layer, and a high thermal expansion polyimide resin having thermal expansion coefficient of more than 20 ppm/° C. loaded on the above low thermal expansion polyimide resins, and a preparation method of the same.

The present invention is described in detail hereinafter.

To achieve the above object, double layer metallic laminate of the present invention characteristically contains the first and the second low thermal expansion polyimide resins having thermal expansion coefficient of up to 20 ppm/° C. and a conductor layer.

Another embodiment of double layered metallic laminate of the present invention can have the structure of having high thermal expansion polyimide resin, which has thermal expansion coefficient of more than 20 ppm/° C. and the difference of thermal expansion coefficient of at least 10 ppm/° C. with that of the second low thermal expansion polyimide resin, loaded on the low thermal expansion polyimide resin.

The present invention also provides a preparation method for metallic laminate comprising the following steps: coating metal foil with one of the two (the first and the second) low thermal expansion polyimide precursor solutions having thermal expansion coefficient of up to 20 ppm/° C. and drying thereof, and coating the metal foil serially with the remaining precursor solution, drying and hardening to load the two polyimide resin layers on the metallic conductor layer.

The preparation method above can additionally include the steps of coating the metallic conductor layer pre-coated with low thermal expansion polyimide precursors with high thermal expansion polyimide precursor solution having thermal expansion coefficient of more than 20 ppm/° C. and at least 10 ppm/° C. difference of thermal expansion coefficient with that of the second low thermal expansion polyimide resin, and drying thereof.

Polyimide resin herein means all the resins having imide ring structure, for example polyimide, polyamideimide, polyesterimide, etc. Thermal expansion coefficient is calculated by measuring average coefficient of linear expansion from 100° C. to 200° C. with thermo mechanical analysis (TMA) while heating the sample, in which imidization is completed, at the speed of 10° C./min.

To achieve the object of the present invention, thermal expansion coefficients of both the first and the second low thermal expansion polyimide resins have to be up to 20 ppm, and it is more preferred that the thermal expansion coefficient of the first low thermal expansion polyimide resin is 5-16 ppm/° C., the thermal expansion coefficient of the second low thermal expansion polyimide resin is 16-20 ppm/° C., and the difference of the thermal expansion coefficients between the two polyimide resins is at least 3 ppm/° C. If the difference is far from the acceptable range, uniformity of double layer metallic laminate including a conductor layer will be poor before and after etching.

Metals usable for the metallic laminate of the present invention are exemplified by copper, aluminum, iron, silver, palladium, nickel-chrome, molybdenum, tungsten or their alloys, and among these, copper is most preferred candidate.

Metallic laminate having a bilateral structure is also acceptable herein, but the metallic laminate having a unilateral structure is more preferred to accomplish the object of the invention.

In the present invention, the preferable thickness ratio of the first low thermal expansion polyimide resin to the second low thermal expansion polyimide resin is in the range of 0.01 to 100. If the difference of thickness ratio is less than 0.01 or more than 100, the product has curl, which is even differently expressed after etching, resulting in difficulties in circuit formation.

Polyimide precursor solution used in the present invention is prepared in the form of varnish in which dianhydride and diamine are mixed at the molar ratio of 1:0.9 or 1:1.1 in a proper organic solvent. Metal plate is coated with that varnish at least once and then dried, resulting in a resin layer. The desirable thermal expansion coefficient of a polyimide resin of the invention can be obtained by regulating the mixing ratio of dianhydride to diamine or the mixing ratios between dianhydrides or between diamines, or the kinds of candidate dianhydride and diamine in polyimide precursor solution.

The dianhydride of the present invention can be one or more compounds selected from a group consisting of pyromellitic dianhydride (PMDA), 3,3,4,4-biphenyltetracarboxylic dianhydride (BPDA), 3,3,4,4-benzophenontetracarboxylic dianhydride (BTDA), 4,4-oxydiphthalic anhydride (ODPA), 4,4-(4,4-isopropylbiphenoxy)biphthalic anhydride (BPADA), 2,2-bis-(3,4-dicarboxylphenyl) hexafluoropropane dianhydride (6FDA) and ethyleneglycol bis(anhydro-trimellitate (TMEG).

The diamine of the present invention can be one or more compounds selected from a group consisting of p-phenylenediamine (p-PDA), m-phenylenediamine (m-PDA), 4,4-oxydianiline (4,4-ODA), 3,4′-oxydianiline (3,4′-ODA), 2,2-bis(4-[4-aminophenoxy]-phenyl)propane (BAPP), 1,3-bis(4-aminophenoxy)benzene (TPE-R), 2,2-bis(4-[3-aminophenoxy]phenyl)sulfone (m-BAPS), 3,3′-dihydroxy-4,4′-diamino biphenyl (HAB) and 4,4′-diaminobenzanilide (DABA).

In addition to the above compounds, other kinds of dianhydrides or diamines, or other compounds can be additionally added in the present invention.

An organic solvent useful for preparing polyimide precursor solution is selected from a group consisting of N-methylpyrrolidinone (NMP), N,N-dimethylacetamide (DMAc), tetrahydrofuran (THF), N,N-dimethylformamide (DMF), dimethylsulfoxide (DMSO), cyclohexane, acetonitrile and a mixture thereof, but not always limited thereto.

The preferable content of polyimide precursor in a whole solution is 10-30 weight %. When the content is less than 10 weight %, the use of unnecessary solvent is increased. In the meantime, the content of the precursor more than 30 weight %, viscosity of the whole solution is increased too high to spread evenly.

To facilitate spreading or hardening or to enhance other properties, antifoaming agent, antigelling agent, hardening accelerator, etc, can be additionally included in the resin of the invention.

To perform coating with polyimide precursor solution, die coater, comma coater, reverse comma coater, gravure coater, etc can be used. Besides, other conventional techniques for coating can also be used. The coated varnish is dried in an arch type oven or in a floating type oven at the temperature under boiling point of a solvent, which is 100-350□, more preferably at 140-250□, even though the temperature has to be adjusted according to the structure or conditions of an oven.

As explained above, one section of metal foil is coated with low thermal expansion polyimide precursor or high thermal expansion polyimide precursor and dried. Then, the temperature is raised to 350□, leading to hardening. Hardening of metal foil is induced by raising the temperature slowly in an oven in the presence of nitrogen or in vacuum condition or by making the metal foil pass through high temperature continually.

So, excellent flexible double layer metallic laminate for printed-circuit base board has been produced by the method of the present invention.

The double layer metallic laminate prepared by the present invention has excellent chemical resistance and at least 0.5 kg/cm of adhesive force, up to 4% of moisture absorption rate, at least 13.8×10⁷ Pa of tensile strength, at least 25% of elongation percentage and up to 0.5% of stretch thermal contraction rate.

### BEST MODE FOR CARRYING OUT THE INVENTION

Practical and presently preferred embodiments of the present invention are illustrative as shown in the following Examples.

However, it will be appreciated that those skilled in the art, on consideration of this disclosure, may make modifications and improvements within the spirit and scope of the present invention.

Polyimide precursor solutions were synthesized to prepare metallic laminate in Examples and Comparative Examples of the invention and their properties were compared.

### SYNTHETIC EXAMPLE 1

5.2 g of p-PDA and 0.2 g of 4,4′-ODA were dissolved in 100 ml of N-methylpyrrolidinone, to which 14.6 g of BPDA was added, followed by stirring for 24 hours for polymerization. The temperature for polymerization was set to 5□. The temperature of the reaction solution was raised to 350□ to induce hardening, resulting in 25 μm thick film. While raising the temperature by 10□/minute, coefficient of linear expansion of the film was measured by using TMA. As a result, the average coefficient of linear expansion of the product in the temperature range between 1000 to 200□ was 9 ppm/□.

### SYNTHETIC EXAMPLES 2-11

Polyimide precursor solutions were prepared by using dianhydride and diamine, shown in Table 1, by the same method as described in Synthetic Example 1, and their coefficients of linear expansion were measured.

TABLE 1

| | | | | | Coefficient of |
|---|---|---|---|---|---|
| | | | | | linear expansion |
| | Dianhydride (g) | | Diamine (g) | | ×10⁻⁶(1/□) |
| Synthetic | BPDA | BTDA | p-PDA | — | 16 |
| Example 2 | 10.7 | 4.2 | 5.1 | | |
| Synthetic | BPDA | ODPA | p-PDA | — | 13 |
| Example 3 | 10.1 | 4.6 | 5.3 | | |
| Synthetic | PMDA | BTDA | 4,4′- | HAB | 17 |
| Example 4 | 6.6 | 4.2 | ODA | 7.5 | |
| | | | 1.7 | | |
| Synthetic | BPDA | BTDA | p-PDA | DABA | 13 |
| Example 5 | 6.9 | 7.5 | 4.5 | 1.1 | |
| Synthetic | BPDA | ODPA | p-PDA | DABA | 16 |
| Example 6 | 6.8 | 7.1 | 4.0 | 2.1 | |
| Synthetic | BPDA | PMDA | 4,4′- | HAB | 10 |
| Example 7 | 4.5 | 6.2 | ODA | 6.6 | |
| | | | 2.6 | | |
| Synthetic | BPDA | BPADA | TPE-R | p-PDA | 19 |
| Example 8 | 11.9 | 2.3 | 1.3 | 4.4 | |
| Synthetic | BPDA | BTDA | p-PDA | DABA | 18 |
| Example 9 | 6.5 | 7.1 | 3.3 | 3 | |
| Synthetic | BPDA | TMEG | 4,4′- | HAB | 30 |
| Example 10 | 10.3 | 1.6 | ODA | 4.2 | |
| | | | 3.9 | | |
| Synthetic | BPDA | | 4,4′- | p-PDA | 8 |
| Example 11 | 14.3 | | ODA | 4.7 | |
| | | | 1.0 | | |

### EXAMPLE 1

Copper foil was coated with polyimide precursor solution, prepared in Synthetic Example 1, to make it as thick as shown in Table 2 after hardening. After drying at 140□, it was coated again with polyimide precursor solution prepared in Synthetic Example 2, by the same method as described above, followed by drying. Then, the temperature was raised to 350□ to induce hardening. Adhesive force and expansion rate were measured. The laminate passed the tests of chemical resistance and uniformity before and after etching.

### EXAMPLES 2-7

As shown in Table 2, polyimide precursor solutions were used to produce double layer copper clad laminate by the same method as described in Example 1. Then, adhesive force and expansion rate were measured and the results are shown in Table 2. The double layer copper clad laminates produced in Examples 2-7 passed the tests of chemical resistance and uniformity before and after etching.

### COMPARATIVE EXAMPLE 1

Copper foil was coated with polyimide precursor solution, prepared in Synthetic Example 1, to make it 0.2 μm thick after hardening. After drying at 140□, it was coated again with polyimide precursor solution prepared in Synthetic Example 2, by the same method as described above, resulting in a thickness of 24.8 μm, followed by drying. Then, the temperature was raised to 350□ to induce hardening. At that time, polyimide thin film including a conductor layer was not flat.

TABLE 2

| | | | | | | | Moisture |
|---|---|---|---|---|---|---|---|
| | First layer | | Second layer | | Adhesive | Expansion | absorption |
| | | Thickness | | Thickness | force | rate | rate |
| | Solution | (μm) | Solution | (μm) | (kg/cm) | (%) | (%) |
| Example 1 | Synthetic | 13 | Synthetic | 12 | 1.1 | 0.4 | 2.5 |
| | Example 1 | | Example 2 | | | | |
| Example 2 | Synthetic | 8 | Synthetic | 17 | 1.0 | 0.5 | 2.4 |
| | Example | | Example 8 | | | | |
| | 11 | | | | | | |
| Example 3 | Synthetic | 10 | Synthetic | 10 | 1.2 | −0.4 | 2.2 |
| | Example 3 | | Example 4 | | | | |
| Example 4 | Synthetic | 6 | Synthetic | 6.5 | 1.0 | 0.3 | 2.2 |
| | Example 5 | | Example 2 | | | | |
| Example 5 | Synthetic | 11 | Synthetic | 14 | 1.3 | 0.4 | 2.3 |
| | Example 6 | | Example 7 | | | | |
| Example 6 | Synthetic | 12 | Synthetic | 8 | 1.5 | 0.4 | 2.5 |
| | Example 8 | | Example 5 | | | | |
| Example 7 | Synthetic | 5.5 | Synthetic | 7 | 1.2 | −0.3 | 2.2 |
| | Example 9 | | Example 7 | | | | |

### EXAMPLE 8

Copper foil was coated with polyimide precursor solution, prepared in Synthetic Example 9, to make it 12 μm thick after hardening. After drying at 140□, it was coated again with polyimide precursor solution prepared in Synthetic Example 5, by the same method as described above, followed by drying. The coated copper foil was made 11 μm thick after hardening. Then, the copper foil was coated with polyimide precursor solution, prepared in Synthetic Example 10, to make it 2 μm thick after hardening, followed by drying with the same method as described above. The temperature was then raised to 350□, resulting in hardening of the thin film. The produced double layer copper clad laminate has 1.3 kg/cm of adhesive force, 0.5% of expansion rate, 3% of moisture absorption rate, and 28% of elongation percentage, and chemical resistance and uniformity before and after etching were proved good.

### COMPARATIVE EXAMPLE 2

Copper foil was coated with polyimide precursor solution, prepared in Synthetic Example 3, to make it 20 μm thick after hardening. After drying the coated copper foil at 140□, the temperature was raised to 350□ to induce hardening. The expansion rate of the produced double layer copper clad laminate was 0.6%, and the polyimide thin film including a conductor layer was not flat.

### COMPARATIVE EXAMPLE 3

Copper foil was coated with polyimide precursor solution, prepared in Synthetic Example 10, to make it 20 μm thick after hardening. After drying the coated copper foil at 140□, the temperature was raised to 350□ to induce hardening. The expansion rate of the produced double layer copper clad laminate was 1.0%, and the polyimide thin film including a conductor layer was not flat.

### COMPARATIVE EXAMPLE 4

Copper foil was coated with polyimide precursor solution, prepared in Synthetic Example 10, to make it 3 μm thick after hardening. After drying at 140□, it was coated again with polyimide precursor solution prepared in Synthetic Example 3, by the same method as described above, followed by drying. The coated copper foil was made 22 μm thick after hardening. Then, the temperature was raised to 350□ to induce hardening. The expansion rate of the produced double layer copper clad laminate was 1.2%. At that time, polyimide thin film including a conductor layer was not flat, and polyimide thin film including copper foil was not flat, either.

[Measurement of adhesive force, expansion rate, chemical resistance, moisture absorption rate, and uniformity before and after etching]

The measurement of each property was performed based on IPC-FC-241C.

1) Adhesive force: 2.4.9 peel strength

2) Expansion rate: 2.2.4. Dimensional stability

3) Chemical resistance: 2.3.2. Chemical Resistance of flexible print wiring

The following chemicals were prepared in that order, and the prepared polyimide film was dipped serially in each chemical solution for 1 minute per each. The film was washed with 55□ water and tackiness, blistering, bubbles, delamination, swelling, color change were observed within 30 minutes. 16-24 hours later, observation was performed again and in particular peel strength was measured both in the film exposed on chemicals and in the film not exposed on chemicals. No change on film was regarded as passing through chemical resistance test.

Monoethanol amine 0.5%/KOH 5.0%/monobutylether 0.5% solution, 55±5□;

2N sulfuric acid, 23±5□;

70% isopropanol, 23±5□;

Methyl ethyl ketone, 23±5□.

4) Moisture absorption rate: 2.6.2. Moisture Absorption

5) Uniformity before and after etching:

The copper clad laminate containing polyimide was cut by 25 cm×25 cm. The section was put on a flat table and measured the heights of each edge to make an average. After etching the copper, the average height was also measured like the above. When the average is not more than 0.5 cm, uniformity before and after etching is regarded as appropriate.

### INDUSTRIAL APPLICABILITY

As explained hereinbefore, the double layer metallic laminate prepared by the method of the present invention has excellent adhesive force, moisture absorption rate, thermal contraction percentage, and chemical resistance, in addition to uniformity before and after etching and high productivity.

Those skilled in the art will appreciate that the conceptions and specific embodiments disclosed in the foregoing description may be readily utilized as a basis for modifying or designing other embodiments for carrying out the same purposes of the present invention. Those skilled in the art will also appreciate that such equivalent embodiments do not depart from the spirit and scope of the invention as set forth in the appended claims.

1. A metallic laminate which is characterized by consisting of the first and the second low thermal expansion polyimide resin layers having thermal expansion coefficient of up to 20 ppm/□° C., and a conductor layer.

2. A metallic laminate which is characterized by consisting of the first and the second low thermal expansion polyimide resin layers having thermal expansion coefficient of up to 20 ppm/□° C., a high thermal expansion polyimide resin layer having thermal expansion coefficient of more than 20 ppm/° C., and a conductor layer, having the structure of having the high thermal expansion polyimide resin layer loaded on the low thermal expansion polyimide resin layer and that the difference of thermal expansion coefficients between the second low thermal expansion polyimide resin layer and the high thermal expansion polyimide resin layer is at least 10 ppm/□° C.

3. The metallic laminate as set forth in claim 1 or in claim 2, in which the thermal expansion coefficient of the first low thermal expansion polyimide resin layer is 5-16 ppm/□° C., the thermal expansion coefficient of the second low thermal expansion polyimide resin layer is 16-20 ppm/□° C., and the difference of thermal expansion coefficients of the two is at least 3 ppm/□°C.

4. The metallic laminate as set forth in claim 1 or in claim 2, in which the ratio of the first to the second polyimide resin layer is in the range of 0.01-100.

5. The metallic laminate as set forth in claim 1 or in claim 2, in which the polyimide resin layer is produced from polyimide precursor solution prepared by one or more dianhydrides selected from a group consisting of pyromellitic dianhydride (PMDA), 3,3,4,4-biphenyltetracarboxylic dianhydride (BPDA), 3,3,4,4-benzophenontetracarboxylic dianhydride (BTDA), 4,4-oxydiphthalic anhydride (ODPA), 4,4-(4,4-isopropylbiphenoxy)biphthalic anhydride (BPADA), 2,2-bis-(3,4-dicarboxylphenyl) hexafluoropropane dianhydride (6FDA) and ethyleneglycol bis(anhydro-trimellitate (TMEG) and one or more diamines selected from a group consisting of p-phenylenediamine (p-PDA), m-phenylenediamine (m-PDA), 4,4-oxydianiline (4,4-ODA), 3,4′-oxydianiline (3,4′-ODA), 2,2-bis(4-[4-aminophenoxy]-phenyl)propane (BAPP), 1,3-bis(4-aminophenoxy)benzene (TPE-R), 2,2-bis(4-[3-aminophenoxy]phenyl)sulfone (m-BAPS), 3,3′-dihydroxy-4,4′-diamino biphenyl (HAB) and 4,4′-diaminobenzanilide (DABA).

6. The metallic laminate as set forth in claim 1 or in claim 2, in which the conductor layer is copper foil.

7. A preparation method for the metallic laminate, which is characterized by the steps of coating metal foil with one of the first and the second low thermal expansion polyimide precursor solutions having thermal expansion coefficient of up to 20 ppm□ ° C., drying thereof, coating with the rest of the two low thermal expansion polyimide precursor solutions again, drying, and hardening to load the two low thermal expansion polyimide resin layers on the metal conductor layer.

8. The preparation method for the metallic laminate as set forth in claim 7, which additionally includes the steps of coating the metal foil coated with the first and the second low thermal expansion polyimide precursor solutions with high thermal expansion polyimide precursor solution having thermal expansion coefficient of more than 20 ppm/□° C., and at least 10 ppm/□° C., of the difference of the coefficient with that of the second low thermal expansion polyimide resin, and drying thereof.

9. The preparation method for the metallic laminate as set forth in claim 7 or in claim 8, in which the thermal expansion coefficient of the first low thermal expansion polyimide resin layer is 5-16 ppm/□° C., the thermal expansion coefficient of the second low thermal expansion polyimide resin layer is 16-20 ppm/□° C., and the difference of thermal expansion coefficients of the two is at least 3 ppm/□° C.

10. The preparation method for the metallic laminate as set forth in claim 7 or in claim 8, the ratio of the first to the second polyimide resin layers is in the range of 0.01-100.

11. The preparation method for the metallic laminate as set forth in claim 7 or in claim 8, in which the polyimide precursor solution is prepared by one or more dianhydrides selected from a group consisting of pyromellitic dianhydride (PMDA), 3,3,4,4-biphenyltetracarboxylic dianhydride (BPDA), 3,3,4,4-benzophenontetracarboxylic dianhydride (BTDA), 4,4-oxydiphthalic anhydride (ODPA), 4,4-(4,4-isopropylbiphenoxy)biphthalic anhydride (BPADA), 2,2-bis-(3,4-dicarboxylphenyl) hexafluoropropane dianhydride (6FDA) and ethyleneglycol bis(anhydro-trimellitate (TMEG) and one or more diamines selected from a group consisting of p-phenylenediamine (p-PDA), m-phenylenediamine (m-PDA), 4,4-oxydianiline (4,4-ODA), 3,4′-oxydianiline (3,4′-ODA), 2,2-bis(4-[4-aminophenoxy]-phenyl)propane (BAPP), 1,3-bis(4-aminophenoxy)benzene (TPE-R), 2,2-bis(4-[3-aminophenoxy]phenyl)sulfone (m-BAPS), 3,3′-dihydroxy-4,4′-diamino biphenyl (HAB) and 4,4′-diaminobenzanilide (DABA).

12. The preparation method as set forth in claim 7 or in claim 8, in which the conductor layer is copper foil.
